(19) United States
(12) Patent Application Publication
(10) Pub. No.: US 2014/0146558 A1
(43) Pub. Date: May 29, 2014

(54) LIGHT GUIDE STICK AND LIGHT SOURCE ASSEMBLY HAVING LIGHT EMITTING DIODE AND LIGHT GUIDE STICK

(71) Applicant: HON HAI PRECISION INDUSTRY CO., LTD., New Taipei (TW)

(72) Inventor: PO-CHOU CHEN, New Taipei (TW)

(73) Assignee: HON HAI PRECISION INDUSTRY CO., LTD., New Taipei (TW)

(21) Appl. No.: 13/865,215

(22) Filed: Apr. 18, 2013

(30) Foreign Application Priority Data
Nov. 26, 2012 (TW) 101144112

(51) Int. Cl. F21K 99/00; F21V 8/00

(52) U.S. Cl. CPC F21K 9/52; G02B 6/0001
USPC 362/555; 362/577

(57) ABSTRACT

A light source assembly includes a light emitting diode and a light guide stick. The light guide stick includes an incident surface, a rear surface opposite to the incident surface, and a side surface connected between the incident surface and the rear surface. The light emitting diode faces the incident surface for emitting light to the incident surface. The light guide stick includes a plane passing through its center axis. The side surface includes a light reflection part and a light emission part. A projection of the light emission part on the plane is substantially a rectangle. Long sides of the rectangle are parallel to the center axis. The light reflection part is coated with a reflection layer.

### BACKGROUND

1. Technical Field

The present disclosure relates to light source assemblies and, particularly, to a light guide stick and a light guide assembly having a light emitting diode (LED) and the light guide stick.

2. Description of Related Art

Typically, a number of LEDs are arranged in a line to form a linear light source. Employing so many LEDs consumes a lot of power and increases the cost of the light source.

Therefore, it is desirable to provide a light guide stick and light source assembly, which can overcome the above-mentioned problems.

### BRIEF DESCRIPTION OF THE DRAWING

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric schematic view of a light guide stick, according to an exemplary embodiment.

FIG. 2 is a left-side view of the light guide stick of FIG. 1.

FIG. 3 is a cross-sectional view taken along line of FIG. 1.

FIG. 4 is a cross-sectional view of a light source assembly having an LED and the light guide stick of FIG. 3, according to an exemplary embodiment.

### DETAILED DESCRIPTION

Embodiments of the present disclosure will now be described in detail with reference to the drawings.

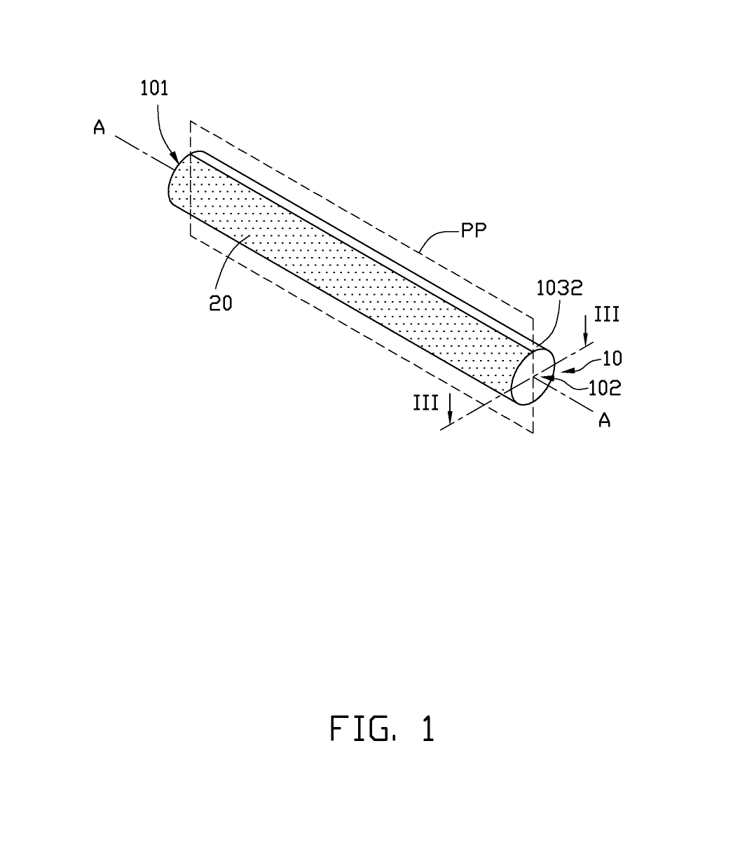

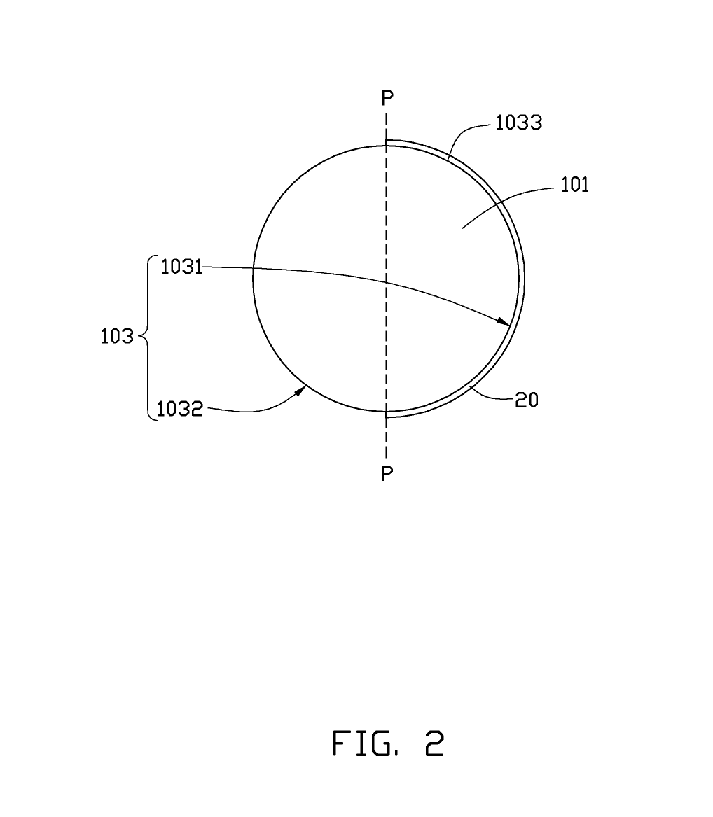

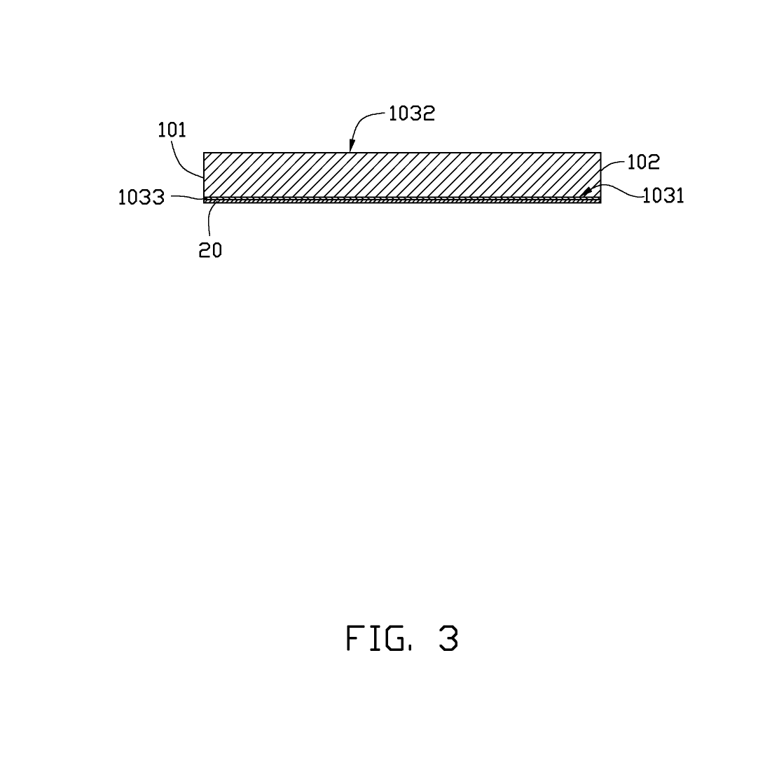

FIGS. 1 to 3 show a light guide stick 10 in accordance with an exemplary embodiment.

The light guide stick 10 is made of transparent material and is cylindrical. The light guide stick 10 can be made of one material selected from poly methyl methacrylate (PMMA), poly carbonate (PC), silicone, and glass. In the embodiment, the light guide stick 10 is made of PMMA by injection molding.

The light guide stick 10 includes a circular incident surface 101, a circular rear surface 102 opposite to the incident surface 101, and a side surface 103 perpendicular to and connected between the incident surface 101 and the rear surface 102. The light guide stick 10 is symmetrical about a center axis AA thereof. The side surface 103 is divided into two parts by a plane PP passing through the center axis AA. The two parts include a light reflection part 1031 and a light emission part 1032. An area of the light reflection part 1031 is equal to an area of the light emission part 1032, namely each of the light reflection part 1031 and the light emission part 1032 is a half of the side surface 103. The light reflection part 1031 is firstly processed by grinding to form a rough layer 1033 and then the rough layer 1033 is coated with a reflection layer 20. The reflection layer 20 can be made of aluminum, nickel, or copper. In the embodiment, the reflection layer 20 is made of aluminum.

In alternative embodiments, the area of the light emission part 1032 can be less than the area of light reflection part 1031. The projection of the light emission part 1032 on the plane PP is substantially a rectangle and long sides of the rectangle are parallel to the center axis AA.

In alternative embodiments, when manufacturing the light guide stick 10, a mold (not shown) for forming the light reflection part 1031 is ground so that the rough layer 1033 is formed during injection molding. Therefore a grinding process for the light reflection part 1031 to form the rough layer can be omitted.

In alternative embodiments, the light guide stick 10 does not have the rough layer 1033.

In alternative embodiments, the rear surface 102 is also firstly ground to form the rough layer 1033 and then is coated with the reflection layer 20 on the rough layer 1033 of the rear surface 102. In alternative embodiments, the reflection layer 20 is directly coated on the rear surface 102.

In alternative embodiments, the light guide stick 10 can be cuboid.

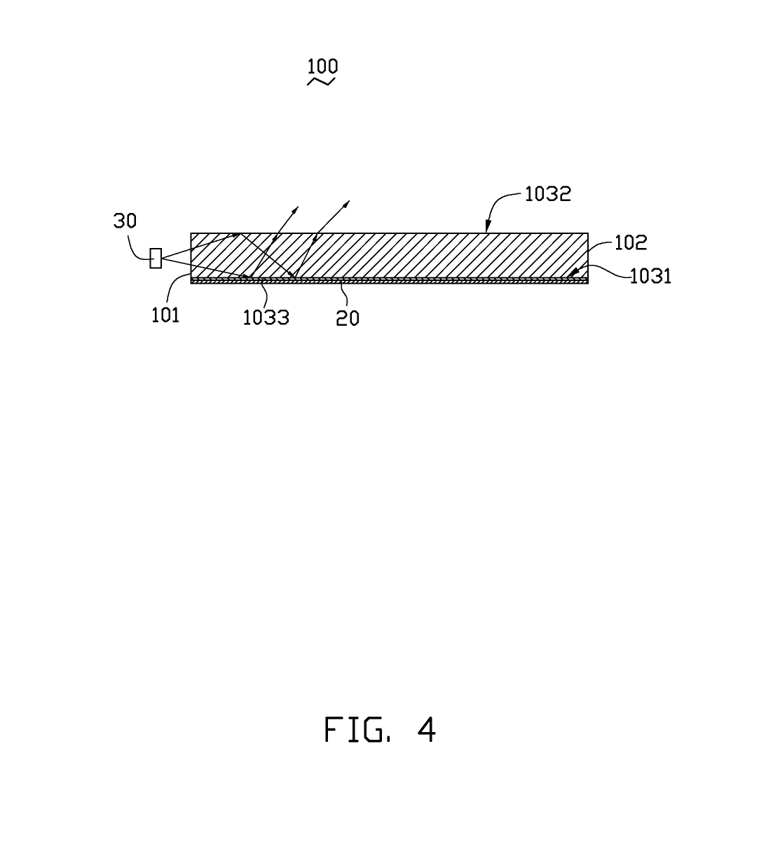

FIG. 4 shows a light source assembly 100 in accordance with an exemplary embodiment. The light source assembly 100 includes an LED 30 and the light guide stick 10 of FIG. 1.

The LED 30 is positioned to face the incident surface 101. Light emitted by the LED 30 enters into the light guide stick 10 via the incident surface 101. A part of the light directly strikes the light emission part 1032 and then emits to the outside of the light guide stick 10 via the light emission part 1032. Another part of the light strikes the light reflection part 1031, this part of the light is reflected to the light emission part 1032 by the reflection layer 20, and then emits to the outside of the light guide stick 10 via the emission part 1032. Only a minority part (i.e., vary small amount of the total) of the light strikes on the rear surface 102 and emits to the outside of the light guide stick 10 via the rear surface 102. The light guide stick 10 appears as a linear light source as the light emits from the light emission part 1032.

The rear surface 102 can be also coated with the reflection layer 20 such that the minority part of the light which strikes the rear surface 102 is reflected to the light emission part 1032.

In the embodiment, the rough layer 1033 disperses the part of the light which strikes on the light reflection part 1031 to make this part of the light more uniform.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A light guide stick, comprising:
an incident surface;
a rear surface opposite to the incident surface; and
a side surface connected between the incident surface and the rear surface;
wherein the light guide stick comprises a plane passing through its center axis, the side surface comprises a light reflection part and a light emission part, a projection of the light emission part on the plane is substantially a rectangle, long sides of the rectangle are parallel to the center axis, and the light reflection part is coated with a reflection layer.

2. The light guide stick of claim 1, wherein the side surface is divided into the reflection part and the emission part by the plane.

3. The light guide stick of claim 2, wherein the light guide stick is cylindrical, and each of the light reflection part and the light emission part is a half of the side surface.

4. The light guide stick of claim 2, wherein the light reflection part is ground to form a rough layer, and the reflection layer is coated on the rough layer.

5. The light guide stick of claim 1, wherein the rear surface is coated with the reflection layer.

6. A light source assembly, comprising:
a light emitting diode; and
a light guide stick comprising:
an incident surface;
a rear surface opposite to the incident surface; and
a side surface connected between the incident surface and the rear surface;
wherein the light emitting diode faces the incident surface for emitting light to the incident surface, the light guide stick comprises a plane passing through its center axis, the side surface comprises a light reflection part and a light emission part, a projection of the light emission part on the plane is substantially a rectangle, long sides of the rectangle are parallel to the center axis, and the light reflection part is coated with a reflection layer.

7. The light source assembly of claim 6, wherein the side surface is divided into the light reflection part and the light emission part by the plane.

8. The light source assembly of claim 7, wherein the light guide stick is cylindrical, and each of the light reflection part and the light emission part is a half of the side surface.

9. The light source assembly of claim 7, wherein the light reflection part is ground to form a rough layer, and the reflection layer is coated on the rough layer.

10. The light source assembly of claim 6, wherein the rear surface is coated with the reflection layer.
